(19) United States
(12) Patent Application Publication
(10) Pub. No.: US 2021/0095138 A1
(43) Pub. Date: Apr. 1, 2021

(54) USE OF A FLUORESCENT OPTICAL BRIGHTENER OR PHOSPHORESCENT INDICATOR WITHIN CERAMIC COATINGS FOR VISUAL DETECTION AND IDENTIFICATION

(71) Applicant: B&B Blending, LLC, Northglenn, CO (US)

(72) Inventor: Christopher R. Gallahar, Westminster, CO (US)

(21) Appl. No.: 17/029,198

(22) Filed: Sep. 23, 2020

Related U.S. Application Data
(60) Provisional application No. 62/907,273, filed on Sep. 27, 2019.

(51) Int. Cl. C09D 5/22; C09D 7/20; C09D 183/16; C04B 41/48; C04B 41/83

(52) U.S. Cl. CPC C09D 5/22; C09D 7/20; C04B 41/83; C04B 41/488; C09D 183/16

(57) ABSTRACT

The disclosure describes a ceramic coating formulation and a method for visual identification of the ceramic coating formulation on a substrate. The ceramic coating formulation comprises a solvent, wherein the solvent is one of an organic or an inorganic solvent; one or more liquid polymers, wherein the one or more liquid polymers are solvated in the solvent; a visual indicator, wherein the visual indicator is one of a fluorescing optical brightener, a phosphorescent indicator, an optical brightening agent, a fluorescent brightening agent, or a fluorescent whitening agent. In some embodiments, the visual indicator provides for one or more of a positive identification of the ceramic coating formulation's presence on a coated substrate, visual distinction, visual detection, aided visualization during training, application, wear indication, weatherability indication, layering identification, maintenance assessment, leveling state, and a curing state, for instance, under ultraviolet (UV) light conditions.

### CLAIM OF PRIORITY UNDER 35 U.S.C. § 119

The present application for patent claims priority to U.S. Provisional Application Ser. No. 62/907,273 entitled “Use of an Optical Brightener or Phosphorescent Indicator Within Ceramic Coatings for Visual Detection and Identification”, filed Sep. 27, 2019 and assigned to the assignee hereof and hereby expressly incorporated by reference herein.

### FIELD OF THE DISCLOSURE

The present invention relates to the use of a visual indicator in ceramic coatings. More specifically, the present invention relates to the use of a fluorescent optical brightener or phosphorescent indicator within ceramic coatings for visual detection and identification.

### DESCRIPTION OF RELATED ART

Traditionally, visual identification in ceramic coatings has relied on using various pigmentations for the coating. In some cases, the use of pigments as a visual distinction of the coating is primarily for the purposes of altering the visual aesthetics of the substrates, rather than for aid of application, training, wear indication, or positive identification. In some cases, pigments also change the color and/or transparency of the film generated by the coating. Thus, there is a need for a technique for positively identifying a coating's presence without altering the underlying substrate's aesthetics by leaving the liquid matrix of the coating completely clear and transparent.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below. For the purposes of this disclosure, the terms ceramic coating and coating may be used interchangeably throughout this application. Further, the terms tracer, visual indicator, and visual tag may be used interchangeably throughout this application, and may be broadly used to refer to one or more of a ultraviolet (UV) and phosphorescent tag, such as a fluorescing optical brightener (FOB), optical brightening agent (OBA), fluorescent brightening agent (FBA), fluorescent whitening agent (FWA), or phosphorescent indicator in a ceramic coating.

The current disclosure aims to alleviate some of the problems associated with positive identification of a coating's presence, traceability of a coating's whereabouts during application and wipe down, gauging how a freshly applied coating is leveling, and verifying that it has been wiped down properly, for instance, during training and when used as an application aid. In some cases, aspects of the current disclosure also relate to a wear indicator, which may be used to confirm that a coating is still residing on a surface by visual inspection alone. Broadly, the current disclosure allows for positive identification of a coating's presence and detection of the quality of the applied coating (e.g., inconsistent application, missing some spots, varying thickness of coating layer, etc.) through the use of a fluorescing optical brightener (FOB), optical brightening agent (OBA), fluorescent brightening agent (FBA), or fluorescent whitening agent (FWA) within the formulation of the ceramic coating—causing it to glow under ultraviolet (UV) light. Additionally or alternatively, a phosphorescent indicator may also be included in the ceramic coating's formulation for a similar purpose.

The described techniques relate to improved methods and formulations for the use of a visual indicator in ceramic coatings. Some embodiments of the invention may be characterized as a ceramic coating. In some cases, the ceramic coating may include an air temperature curable (ATC) refractory resin. Refractory resins may refer to resins that are resistant to decomposition by one or more of heat, pressure, or chemical attack, and retain strength and/or form at high temperatures (e.g., above 500 degrees Celsius, above 750 degrees Celsius, etc.). In some cases, the refractory resin may be, for instance, a silicone-based resin, or a polysilazane-based resin designed for high-temperature applications. In some examples, the loading level (e.g., by weight) of the refractory resin in the ceramic coating may vary based on the use case or application. For instance, the loading level may be anywhere from about 0.1% to about 99% by weight, such as from about 2.5% to about 60% by weight. While traditional coatings utilizing refractory resins require curing at high temperatures, ATC refractory resins may support curing under ambient or room temperature conditions (e.g., 20-24 degrees Celsius), while maintaining corrosion protection at substantially higher temperatures. In some cases, the functional groups (e.g., alkoxy) in the ATC resin, in combination with catalysts (e.g., tin-free catalysts), may allow the hydrolysis-condensation reaction (i.e., crosslinking in the system) to occur at ambient temperatures.

In some other cases, the ceramic coating may include one or more other resins, such as a silicate resin, a high flow additive such as a fluorinated silicone, an adhesion promoter such as an amino-functional silicone resin, or other additives designed to impart various characteristics to the coating's performance or application. In some examples, the loading levels of the additives or resins in the ceramic coating may vary from about 0.25% to about 25% by weight, for instance, from about 2.5% to about 4.5% by weight. In some cases, the ceramic coating may also include a visual indicator such as a fluorescing optical brightener, OBA, FBA, FWA, or a phosphorescent indicator in the form of a powder or liquid dye or dispersible pigment, where the loading level within the ceramic coating formulation may vary from about 0.01% to about 2% by weight (e.g., based on a total weight of the ceramic coating formulation). In one example, the loading level of the visual indicator may be approximately 0.1% by weight.

In some cases, the fluorescing optical brightener may be an example of a chemical compound that absorbs light in the UV and/or violet region of the electromagnetic spectrum, and re-emits light in the visible region (e.g., blue region ˜420-470 nm) via fluorescence. Some examples of fluorescing optical brighteners include a class of compounds referred to as stilbenes, which includes 4,4′-diamino-2,2′-stilbenedisulfonic acid, which may typically be added within the formulation at a loading level of about 0.01% to about 2% by weight, for instance, about 0.1% by weight (e.g., based on a total weight of the ceramic coating formulation).

In some cases, phosphorescent indicators may be used in addition to, or instead of, the optical brighteners. In some cases, such indicators may provide an analogous method of traceability with the primary difference between the fluorescent optical brighteners and phosphorescent indicators being the period of light emission following UV excitation. One example of a phosphorescent indicator may include a europium-doped strontium silicate-aluminate oxide powder, which may be utilized at the same or similar loading levels (e.g., from about 0.01% to about 2% by weight based on a total weight of the ceramic coating formulation) as the fluorescing optical brighteners.

The following is a listing of representations or expressions of how the disclosed ceramic coating formulation containing a UV or phosphorescent “tag” (i.e., visual indicator) could be deployed within a variety of formulations utilized across a variety of industries for the purposes of providing protection to a given substrate (e.g., in the form of chemical durability), scratch and mar resistance, soap/detergent resistance, UV and oxidative deterioration resistance. Additionally or alternatively, the ceramic coating may be used to enhance gloss or depth of color, ease of maintenance, and overall aesthetics of the underlying substrate.

In some examples, the disclosed ceramic coating formulation may be utilized within industries such as, but not limited to, the automotive, marine, aviation, janitorial, household, industrial, and institutional (HI&I) industries. In some cases, the coating may be adapted to be applied via wipe on/wipe off, for instance, using a ceramic coating applicator. Some non-limiting examples of ceramic coating applicators may include a sponge applicator and/or a micro suede applicator. Alternatively, the coating could be spray applied followed by a wipe down (i.e., to level the coating). In other cases, the coating may be applied via spray application and allowed to set or cure at ambient temperature for a period ranging from about 1 hour to 48 hours, for instance, from about 4 to 48 hours. In another example, the coating may be allowed to set or cure for a period ranging from about 4 to 24 hours. In some circumstances, an infrared (IR) lamp set to medium, short, or long wavelength may be utilized to accelerate the curing time from a period of hours or days (e.g., 1 to 48 hours) to a period of minutes. In one example, coated panels may be cured for about 10 to 15 minutes, although different curing periods are contemplated in other embodiments. In some circumstances, curing time for coated panels may vary depending on the wavelength of IR used, power level of IR radiation, etc. In some embodiments, the ceramic coating formulation comprising the visual indicator may be utilized in products such as fabric protectants, aerosols, paste or liquid waxes, crème lotions, automotive paint sealants (e.g., liquid or spray), leather protectants, water-based and solvent-based detail sprays (i.e., for interior and/or exterior applications), tunnel wash or automatic in-bay car washes, or automotive shampoos (e.g., applied via hand wash or utilizing any of a foam gun, foam cannon, or any other type of hydrofoamer).

Some embodiments of the disclosure may be characterized as a ceramic coating formulation, comprising: a solvent, wherein the solvent is one of an organic or an inorganic solvent at a loading level of about 10% to about 90% by weight based on a total weight of the ceramic coating. In one example, the ceramic coating formulation may comprise about 25% to about 85% of the solvent by weight. The ceramic coating formulation may further comprise one or more liquid polymers, wherein the one or more liquid polymers are solvated in the solvent at a loading level of about 0.25% by weight to about 25% by weight based on a total weight of the ceramic coating, or alternatively, based on a total weight of the solvent. In one example, the ceramic coating formulation, or alternatively, the solvent, may comprise about 2.5% to about 5.5% of the liquid polymer(s) by weight. In some embodiments, the ceramic coating formulation may further comprise a visual indicator, wherein the visual indicator is one of a fluorescing optical brightener, a phosphorescent indicator, an optical brightening agent (OBA), a fluorescent brightening agent (FBA), or a fluorescent whitening agent (FWA). In some examples, the visual indicator provides for one or more of a positive identification of the ceramic coating formulation's presence on a coated substrate, and may assist in: visual distinction, visual detection, aided visualization during training, application, wear indication, weatherability indication, layering identification, maintenance assessment, leveling state, and a curing state.

Other embodiments of the disclosure may be characterized as method of visual identification and detection of a ceramic coating on a substrate, comprising: providing the substrate; providing the ceramic coating; applying the ceramic coating to the substrate, wherein the ceramic coating is comprised of: a solvent, wherein the solvent is one of an organic or an inorganic solvent; one or more liquid polymers, wherein the one or more liquid polymers are solvated in the solvent; one or more additive fluids and polymers; and a visual indicator, wherein the visual indicator is one of a fluorescing optical brightener, a phosphorescent indicator, an optical brightening agent (OBA), a fluorescent brightening agent (FBA), or a fluorescent whitening agent (FWA). In some embodiments, the method may further comprise curing the ceramic coating on the substrate.

In some embodiments, curing the ceramic coating may comprise curing the one or more liquid polymers at or near room temperature into a semi-permanent or permanent film layer on the substrate, wherein the semi-permanent or permanent film layer is composed of at least one of quartz or silicon dioxide, silicon carbide, titanium oxide, antimony-tin oxide, graphene oxide, and reduced graphene oxide.

In some embodiments, the one or more liquid polymers are selected from a group consisting of trimethoxysilicate fluids or resins, silazane, polysilazane, polysiloxazane, perhydropolysilazane, dimethylpolysilazane, hexamethyldisilazane, 1,1,3,3-tetramethyldisilazane, 2,2,4,4,6,6-hexamethylcyclotrisilazane, 1,3-Diethyl-1,1,3,3-tetramethyldisilazane, 2,4,6-trimethyl-2,4,6-trivinylcyclotrisilazane, 1,1,3,3-Tetramethyl-1,3-diphenyldisilazane, or 1,3-dimethyl-1,1,3,3-tetraphenyldisilazane. In some cases, the loading level of the one or more liquid polymers within the ceramic coating formulation may be anywhere from about 0.1% to about 99% by weight. For instance, the ceramic coating formulation may be comprised of: the one or more liquid polymers in an amount from about 2.5% to about 60% by weight based on a total weight of the ceramic coating formulation.

In some embodiments, the ceramic coating formulation further comprises one or more of additive fluids and polymers adapted to vary one or more physical characteristics of the ceramic coating formulation, the physical characteristics selected from a group consisting of hydrophobic or hydrophilic behavior, scratch resistance, mar resistance, gloss, coefficient of friction or slickness, adhesion, anti-graffiti, UV resistance, detergency resistance, or chemical resistance.

In some embodiments, the one or more additive fluids are selected from a group consisting of: fluorocarbons, fluorosilicones, silanes, amino-functional polymers, amino-functional silicones, polydimethylsiloxane (PDMS), or trimethoxysilicates. In some examples, the one or more additive fluids further comprise one of an organic and an inorganic solvent.

In some embodiments, the fluorescing optical brightener is one of a water-borne optical brightener or a solvent-borne optical brightener.

In some embodiments, the phosphorescent indicator is one of a water-borne phosphorescent indicator or a solvent-borne phosphorescent indicator.

In some embodiments, the solvent is a toluene, a xylene, a ketone, an ester, an alcohol, a glycol ether, a glycol ether ester, water, or parachlorobenzotrifluoride (PCBTF).

In some embodiments, the visual indicator is configured to allow the ceramic coating to be perceivable within an UV region of the electromagnetic spectrum.

In some embodiments, the visual indicator is one of a solid powder, a liquid pigment, or a liquid dye.

Although the present disclosed formulation has been described with reference to preferred embodiments, formulators skilled in the profession or art will recognize that changes may be made in form, function, and detail without departing from the spirit and scope of the formulation.

### BRIEF DESCRIPTION OF THE DRAWINGS

Various objects and advantages, and a more complete understanding of the present disclosure, are apparent and more readily appreciated by referring to the following detailed description and to the appended claims when taken in conjunction with the accompanying drawings:

FIGS. 1A and 1B illustrate identical ceramic coating formulations, within glass bottles, with and without a visual indicator, respectively, under ultraviolet (UV) light, in accordance with one or more implementations.

FIGS. 2A and 2B illustrate examples of white, porcelain subway tiles coated with the ceramic coating formulations from FIG. 1, and under UV light, in accordance with one or more implementations.

FIG. 3 illustrates an example of two trim panels coated with the same ceramic coating formulation, but only one of them containing a visual indicator, and exposed to UV light, in accordance with one or more implementations.

FIG. 4 is an example of a refrigerator partially coated with a ceramic coating containing a visual indicator for visual indication and identification of the coating's whereabouts when exposed to UV light, in accordance with one or more implementations.

FIG. 5 is an example of a pair of identical microfiber towels, only one of which is coated with a sprayable ceramic coating formulation with a visual indicator, under UV light conditions, in accordance with one or more implementations.

FIG. 6 illustrates a method for using a ceramic coating with a visual indicator for visual identification and detection, in accordance with one or more implementations.

### DETAILED DESCRIPTION

The words “for example” are used herein to mean “serving as an example, instance, or illustration.” Any embodiment described herein as “for example” are not necessarily to be construed as preferred or advantageous over other embodiments.

In some cases, a ceramic coating may be an example of a liquid polymer (i.e., composed of multiple, bonded molecules) capable of providing a semi-permanent (or permanent) layer of water repellant protection when cured into a film. In some embodiments, ceramic coatings may provide a layer of a 9H (or similar) or greater hardness. It should be noted that, 9H refers to the current highest layer of hardness with regards to the pencil scale according to ASTM D3363—Standard Test Method for Film Hardness by Pencil Test. In some cases, after ceramic coatings are left to cure on the surface of a substrate (e.g., automotive clear coat, metal, glass, ceramics, plastics, stainless steel, aluminum, etc.), they may harden to create a glass-like, quartz, silicon-carbide, titanium oxide, or even graphene oxide based flat layer of protection, which may be from about 0.1 micrometers to about 10 micrometers in thickness, such as, from about 2 to 3 micrometers. In such cases, the ceramic coatings may also be referred to as “nano” coatings. As noted above, the ceramic coatings may be cured at or near ambient temperature (e.g., typical room temperature of 22-25 degrees Celsius) for a period ranging from about 24 hours (1 day) to about one week. In one example, a ceramic coating may be cured for at least 48 hours, although different curing times are contemplated in other embodiments. For instance, some ceramic coating formulations may be cured for about two weeks (e.g., 12-18 days).

In some circumstances, ceramic coatings may impart the substrate with one or more of: water repellency, UV ray protection, protection from dirt, dust, debris and environmental weathering, detergency resistance, anti-graffiti, slick feel, scratch or abrasion resistance, etc. In some cases, ceramic coatings may be colorless, off-white, or water-white, often clear and transparent, although other colors and opacity are contemplated in different embodiments. In some cases, ceramic coatings may be hydrophobic (i.e. generate a high contact angle when exposed to water), and may cause water to bead up and roll off the surface along with dirt or other contaminants to generate a self-cleaning or more easily maintained surface. The contact angle of water with a surface may be defined as the angle between a tangent drawn to the drop of water as it contacts the surface and a line parallel with the surface. In some examples, a surface may be hydrophobic or super-hydrophobic if the contact angle is above 90 degrees and 120 degrees, respectively. For instance, a surface where a contact angle for a water droplet exceeds 150 degrees may be referred to as super-hydrophobic (or ultra-hydrophobic).

Alternatively, in some cases, ceramic coatings may be hydrophilic (i.e. generate a low contact angle when exposed to water), which may cause water to flatten and sheet off the surface along with dirt or other contaminants. Hydrophilic ceramic coatings may also serve to generate a self-cleaning or more easily maintained surface. In some cases, a surface may be hydrophilic or super-hydrophilic if the contact angle is below 90 degrees and 45 degrees, respectively. For instance, a surface with a contact angle less than 10 or 20 degrees may be referred to as super-hydrophilic. Further, in some other cases, ceramic coatings may exhibit a combination of both hydrophobic and hydrophilic behavior (i.e. generate a moderate contact angle, measuring greater than 45° but less than 90°, when exposed to water), causing the water to both bead up and roll off the surface or flatten and sheet off the surface along with dirt or other contaminants, such as dust and debris, to generate a self-cleaning or more easily maintained surface.

In some cases, ceramic coatings may comprise varying levels, broadly ranging from about 0.1% to about 99% by weight, of silicon dioxide (SiO₂), titanium oxide (TiO₂), graphene oxide (GO), reduced graphene oxide (rGO), silicon carbide (SC), fluorine or fluorinated polymers, brightening silicon particles, tin or titanium oxide or dioxide (titania) based catalysts, amino-functional silicone fluids or resins, trimethoxysilicate fluids or resins, silazane, polysilazane, polysiloxazane, perhydropolysilazane, dimethylpolysilazane, or other metal oxides like antimony-tin oxide. In some cases, ceramic coating formulations may comprise one or more visual indicators which may facilitate positive identification of the coating's presence and traceability of the coating's whereabouts during application and wipe down, thus serving as an application aid. In some cases, the use of a visual indicator in ceramic coatings may also enhance techniques for determining how the coating is leveling and/or if it has been wiped down or leveled properly, thus serving as a training tool. Additionally or alternatively, the use of a visual indicator in a ceramic coating may also serve as a wear indicator and provide proof that the coating is still residing on a surface by visual inspection under UV light alone. In some cases, the visual indicator may be a fluorescing optical brightener that glows under UV light. Alternatively, the visual indicator may be a phosphorescent indicator. The use of a fluorescing optical brightener or phosphorescent indicator within a ceramic coating may allow the coating to remain unperceivable within the visual spectrum, but glow under the ultraviolet (UV) spectrum. In such cases, the visual indicator may serve to preserve the natural aesthetics of the substrate being coated by allowing the coating film to remain clear, transparent, and/or colorless.

In some cases, a fluorescing optical brightener may be a chemical compound that absorbs light in the UV and violet region (˜340-370 nm) of the electromagnetic spectrum, and re-emits light in a visible region, such as a blue region (˜420-470 nm) via fluorescence. Fluorescence may be defined as the instantaneous emission of light by a substance that has absorbed UV light or other electromagnetic radiation. In some cases, fluorescence may occur when an orbital electron of a molecule, atom, or nanostructure relaxes to its ground state by emitting a photon from an excited state. In some cases, the emitted light may have a longer wavelength and lower energy than the incident (or absorbed) radiation. In some other cases, the emitted light may have a shorter wavelength than the absorbed radiation. For instance, in some cases, such as when the absorbed radiation is intense (i.e., exceeds a threshold), an electron may absorb two photons. In such cases, the two-photon absorption may lead to an emission of radiation having a shorter wavelength than the incident radiation.

In some cases, the UV region of the spectrum is invisible to the human eye, and fluorescent objects or materials may emit visible light when exposed to UV light, for example, via a handheld black light. While a blue glow is commonly associated with fluorescence, it should be noted that some fluorescent or phosphorescent materials may emit red, green, orange, yellow, pink, or combinations of colored glows. In some cases, fluorescent materials may also demonstrate fluorescence while excited by radiation within the visible region, such as a blue or violet light.

In some cases, phosphorescent indicators may be used in addition to, or instead of the fluorescent optical brighteners. In some cases, such indicators may provide an analogous method of traceability with the primary difference from the fluorescent optical brighteners being the length of emission of light from UV excitation. Specifically, fluorescent emissions may be relatively short-lived period of light emissions, usually instantaneous, by a fluorescent material (i.e., fluorophore), as compared to phosphorescent emissions. In some cases, unlike fluorescence, phosphorescent materials may not immediately re-emit the incident radiation. In some circumstances, the prolonged time scales of re-emissions from phosphorescent materials may be associated with slow “forbidden” energy state transitions. In such cases, some phosphorescent materials may re-emit absorbed radiation at lower intensities for several minutes, or even hours, after the original excitation. In some cases, phosphorescence may be noticed by exposing a material (e.g., glow in the dark toys, glow stickers, clock dials, substrate comprising a ceramic coating with phosphorescent materials, etc.) to light (e.g., UV light), and observing the energy absorbed by the material as it is slowly re-emitted.

In some cases, the use of a fluorescing optical brightener or phosphorescent indicator for visual identification, instead of a pigment, may enable the color or transparency of the film to remain unchanged. Further, the liquid matrix (i.e., formed by dissolving resins, fluids, polymers, flakes or powders in solvents via mixing or stirring) of the coating may remain colorless, clear and transparent as well. In current techniques, pigments, not dyes or UV/phosphorescent tracers are added as a means of visual distinction of the coating, which tend to permanently alter the substrates visual aesthetics. According to aspects of the present disclosure, a tracer, such as a fluorescing optical brightener or phosphorescent indicator, may be incorporated into the binder or polymer resin backbone (e.g., a polysilazane-based resin) by mixing or stirring the tracer into the liquid matrix until it is fully dissolved visually. By doing this, the tracer may follow the resin and become impregnated into the coating film, thus allowing for detection of the coating's whereabouts when exposed to UV light. It should be noted that, the coating film may result from ambient temperature curing the ceramic coating formulation on the substrate following application.

In some cases, the visual indicators may facilitate observance of wear patterns, for instance, due to abrasion or washing. In some cases, the visual indicators may also optimize current training techniques for applying, leveling, wiping down, etc., a ceramic coating. In some regards, the visual indicators may simplify the process for gauging how a coating is leveling, as well as establishing the quality of the applied coating (e.g., determining if it has been wiped down and leveled properly).

In some cases, the visual indicator may be a water-borne or solvent-borne fluorescent optical brightener, pigment or dye. In some other cases, the visual indicators may be a water-borne or solvent-borne phosphorescent indicator, pigment or dye. In some cases, a solvent-borne visual indicator may be soluble in a solvent primarily composed of organic compounds. Some examples of organic or hydrocarbon solvents may include toluene, xylene, ketones, esters, alcohols, glycol ethers, glycol ether esters, tert-butyl acetate, n-butyl acetate, parachlorobenzotrifluoride (PCBTF), etc. In some cases, these solvents may contain little to none Volatile Organic Compounds (VOCs), which may serve to mitigate environmental and respiratory issues commonly associated with evaporation of organic solvents.

In some cases, a ceramic coating may comprise one or more of: a solvent (i.e. organic or inorganic solvent), a binder or polymer backbone resin (e.g., polysilazane-based) at loading levels such as those previously described, an extender, pigment(s), such as those disclosed herein, and one or more additives, such as fluorinated silicones for flow, silanes for adhesion, and polydimethysiloxanes for slip. These additives may assist in ease of application and/or may consist of resins or polymers, such as amino-functional siloxanes or trimethoxysilicates, to impart additional characteristics such as weatherability, gloss, viscosity. Additionally or alternatively, these additives may also aid in odor control of the ceramic coating. In some cases, the solvent may reduce the viscosity of the ceramic coating, which may not only allow for easier application, but also act as a carrying medium for application of the coating resin(s). In some cases, one or more additives may be used to modify the properties of the liquid, dry film, or both, for desirable properties such as viscosity, cure rate, slickness, gloss, hydrophobicity, hydrophilicity, adhesion, UV resistance, detergency resistance, film thickness, or oxidation protection, to name a few non-limiting examples.

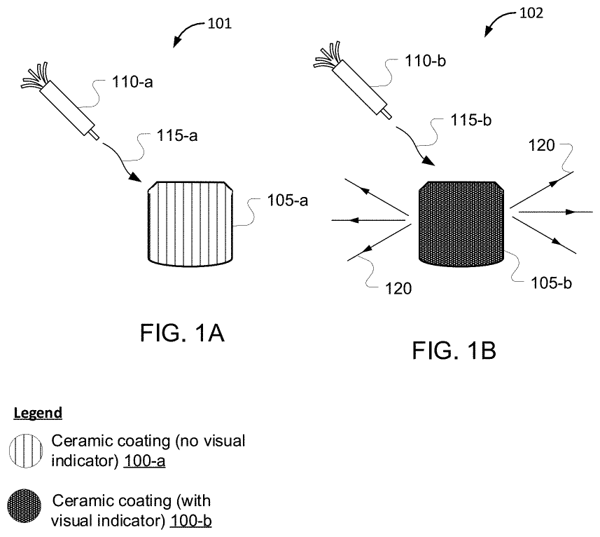

FIGS. 1A and 1B illustrate systems 101 and 102, respectively. In some cases, systems 101 and 102 may relate to identical ceramic coating formulations with and without a visual indicator (e.g., a fluorescent optical brightener), respectively, and exposed to UV light, in accordance with one or more implementations. In some cases, FIGS. 1A and 1B implement one or more aspects of the other figures described herein. As shown, FIG. 1A illustrates a glass bottle 105-a comprising a ceramic coating formulation 100-a without any visual indicators. Further, FIG. 1B illustrates a glass bottle 105-b comprising a ceramic coating formulation 100-b with a visual indicator, such as those described throughout the rest of this application. In some embodiments, the glass bottles 105 may be examples of transparent, clear, and colorless glass bottles. In some other cases, the glass bottles 105 may be translucent and/or colored.

In some cases, the visual indicator in the ceramic coating 100-b may facilitate positive identification of the coating's presence and traceability of the coating's whereabouts during application and wipe down. In some regards, the visual indicator may serve as an application aid and/or as a training tool. For instance, the visual indicator may enhance techniques for determining how the coating is leveling and/or if it has been wiped down or leveled properly. Additionally or alternatively, the visual indicator in ceramic coating 100-b may also serve as a wear indicator and may be used to provide proof that the coating is still residing on a surface or substrate, for instance, by visual inspection under UV light alone.

In some cases, the UV region of the spectrum is invisible to the human eye, and fluorescent objects or materials may emit visible light when exposed to UV light (e.g., via a handheld black light). While a blue glow is commonly associated with fluorescence, it should be noted that some fluorescent or phosphorescent materials may emit red, green, orange, yellow, pink, or combinations of colored glows. In some cases, fluorescent materials may also demonstrate fluorescence while excited by radiation within the visible region, such as a blue or violet light.

As illustrated, the glass bottles 105 (e.g., glass bottles 105-a and 105-b) comprising the ceramic coatings 100 (e.g., ceramic coatings 100-a and 100-b) may be illuminated by UV light 115 (e.g., UV light 115-a, UV light 115-b) emanating from UV sources 110 (e.g., UV source 110-a, UV source 110-b). In some cases, the visual indicator in ceramic coating 100-b may be a fluorescing optical brightener that glows under UV light. Additionally or alternatively, the visual indicator may be a phosphorescent indicator. In some cases, such indicators may provide an analogous method of traceability with the primary difference from the fluorescent optical brighteners being the length of emission of light from UV excitation. Specifically, fluorescent emissions may be relatively short-lived period of light emissions, usually instantaneous, by a fluorescent material (i.e., fluorophore), as compared to phosphorescent emissions. In some cases, unlike fluorescence, phosphorescent materials may not immediately re-emit the incident radiation. In some aspects, the prolonged time scales of re-emissions from phosphorescent materials may be associated with slow “forbidden” energy state transitions. In such cases, some phosphorescent materials may re-emit absorbed radiation at lower intensities for several minutes, or even hours, after the original excitation.

In current techniques, pigments, not dyes or UV/phosphorescent tracers are added as a visual distinction of the coating. In some cases, such pigments tend to alter the substrates visual aesthetics. In some cases, the use of a fluorescing optical brightener or phosphorescent indicator within ceramic coating 100-b may allow the coating to remain unperceivable within the visual spectrum, but glow under the UV spectrum. In such cases, the visual indicator may serve to preserve the natural aesthetics of the coated substrate (not shown) by allowing the coating film to remain unchanged (e.g., clear, transparent, and/or colorless). It should be noted that, the liquid matrix of the coating may also remain colorless, clear and transparent in some embodiments. In some examples, the visual inductor, such as a fluorescing optical brightener (e.g., 4,4′-diamino-2,2′-stilbenedisulfonic acid) or a phosphorescent indicator (e.g., europium-doped strontium silicate-aluminate oxide powder), may be added in amounts from about 0.01% to 2% by weight to the ceramic coating formulation. It should be noted that, the percentage ranges described throughout this disclosure are merely examples, and different loading levels are contemplated in other embodiments. For instance, in some cases, the ceramic coating formulation may include at least 3% by weight of the visual indicator.

In some cases, fluorescing optical brightener and/or phosphorescent indicators may be chemical compounds that absorb light in the UV and violet region (˜340-370 nm) of the electromagnetic spectrum, such as UV light 115-b, and re-emit light in a visible region, such as visible light 120 shown in FIG. 1B. In some cases, the visible light 120 emitted via fluorescence or phosphorescence may be in a blue region (˜420-470 nm) or a green region (˜500-565 nm) of the electromagnetic spectrum, although other wavelengths for visible light 120 are contemplated in different embodiments. For instance, in some examples, the visible light 120 may be between 565-590 nm, corresponding to the yellow region of the electromagnetic spectrum. In yet other cases, the visible light 120 may be between 625-740 nm, which corresponds to the red region.

As previously described, the ceramic coatings 100-a and/or 100-b may also be comprised of: a solvent, wherein the solvent is one of an organic or an inorganic solvent at a loading level of about 10% to about 90% by weight based on a total weight of the ceramic coating. In one example, the ceramic coating formulation may comprise about 25% to about 85% of the solvent by weight. The ceramic coating formulation may further comprise one or more liquid polymers, wherein the one or more liquid polymers are solvated in the solvent at a loading level of about 0.25% by weight to about 25% by weight based on a total weight of the ceramic coating, or alternatively, based on a total weight of the solvent. In one example, the ceramic coating formulation, or alternatively, the solvent, may comprise about 2.5% to about 5.5% of the liquid polymer(s) by weight. In some embodiments, the one or more liquid polymers are selected from a group consisting of trimethoxysilicate fluids or resins, silazane, polysilazane, polysiloxazane, perhydropolysilazane, dimethylpolysilazane, hexamethyldisilazane, 1,1,3,3-tetramethyldisilazane, 2,2,4,4,6,6-hexamethylcyclotrisilazane, 1,3-Diethyl-1,1,3,3-tetramethyldisilazane, 2,4,6-trimethyl-2,4,6-trivinylcyclotrisilazane, 1,1,3,3-Tetramethyl-1,3-diphenyldisilazane, or 1,3-dimethyl-1,1,3,3-tetraphenyldisilazane. In some cases, the loading level of the one or more liquid polymers within the ceramic coating formulation may be anywhere from about 0.1% to about 99% by weight. For instance, the ceramic coating formulation may be comprised of: the one or more liquid polymers in an amount from about 2.5% to about 60% by weight based on a total weight of the ceramic coating formulation.

In some embodiments, the ceramic coating formulation further comprises one or more of additive fluids and polymers adapted to vary one or more physical characteristics of the ceramic coating formulation, the physical characteristics selected from a group consisting of hydrophobic or hydrophilic behavior, scratch resistance, mar resistance, gloss, coefficient of friction or slickness, adhesion, anti-graffiti, UV resistance, detergency resistance, or chemical resistance. In some cases, the one or more additive fluids may be selected from a group consisting of: fluorocarbons, fluorosilicones, silanes, amino-functional polymers, amino-functional silicones, polydimethylsiloxane (PDMS), or trimethoxysilicates. In some examples, the one or more additive fluids further comprise one of an organic and an inorganic solvent, such as a toluene, a xylene, a ketone, an ester, an alcohol, a glycol ether, water, a glycol ether ester, or parachlorobenzotrifluoride (PCBTF). In some examples, these additive fluids and/or polymers may be in amounts from about 2.5% to 4.5% by weight based on a total weight of the ceramic coating formulation, or alternatively, the solvent. It should be noted that, different loading levels that are higher or lower than described herein may be contemplated in other embodiments

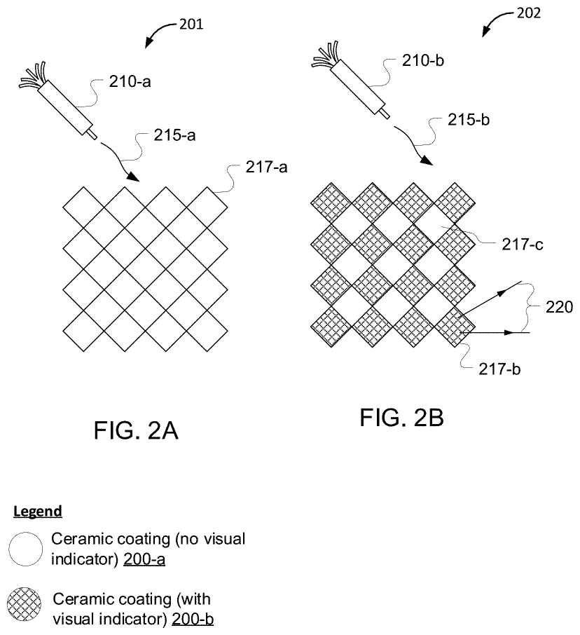

FIGS. 2A and 2B illustrate systems 201 and 202, respectively. As shown, systems 201 and 202 comprise substrates, such as white porcelain subway tiles, coated with ceramic coating formulations, such as those previously described in relation to FIGS. 1A and 1B, respectively. Specifically, FIGS. 2A and 2B illustrate white porcelain subway tiles 217 coated with ceramic coating formulations with and without a visual indicator, such as a fluorescent optical brightener, respectively, and exposed to UV light in accordance with one or more implementations. As shown, FIG. 2A illustrates a plurality of white, porcelain subway tiles 217 (e.g., tile 217-a) coated with a ceramic coating without any visual indicators. Due to the lack of a visual indicator, no traces of the ceramic coating's presence may be observed when UV light 215-a from UV source 210-a radiates the tiles in FIG. 2A.

As seen in FIG. 2B, a portion of the white subway tiles 217 may be coated with a ceramic coating formulation without any visual indicator (e.g., ceramic coating formulation 200-a from FIG. 2A), such as tile 217-c, while the remainder may be coated with a ceramic coating formulation 200-b comprising a visual indicator, such as tile 217-b. Upon illuminating the tiles 217 in FIG. 2B with UV light 215-b from UV source 210-b, the portion of the tiles coated with the ceramic coating with the visual indicator may re-emit light in a visible region (e.g., blue region, green region, orange region, etc.) of the electromagnetic spectrum. For instance, as shown, tile 217-b may re-emit visible light 220 after being illuminated with UV light 215-b. In some cases, the emission of visible light 220 may be instantaneous or nearly instantaneous (i.e., if the visual indicator is a fluorescing optical brightener), or slightly delayed (i.e., if the visual indicator is a phosphorescent indicator). Contrastingly, tile 217-c coated with the ceramic coating 200-a (i.e., without any visual indicators) may not re-emit light in the visible region.

In some cases, the visual indicator in ceramic coating 200-b may facilitate observance of wear patterns on the tiles 217, for instance, due to abrasion or washing. In some cases, the visual indicator may also optimize current training techniques for applying, leveling, wiping down, etc., the ceramic coating 200-b. In some regards, the visual indicator may simplify the process for gauging how the ceramic coating 200-b is leveling and/or determining if it has been wiped down and leveled properly.

In some cases, the visual indicator in ceramic coating 200-b may be a water-borne or solvent-borne fluorescent optical brightener, pigment or dye, such as previously detailed. In some other cases, the visual indicators may be a water-borne or solvent-borne phosphorescent indicator, pigment or dye. In some cases, a solvent-borne visual indicator may be soluble in a solvent primarily composed of organic compounds. Some non-exhaustive examples of organic or hydrocarbon solvents may include toluene, xylene, ketones, esters, alcohols, glycol ethers, glycol ether esters, tert-butyl acetate, n-butyl acetate, parachlorobenzotrifluoride (PCBTF), etc. In some cases, such solvents may contain none (or miniscule) amounts of VOCs.

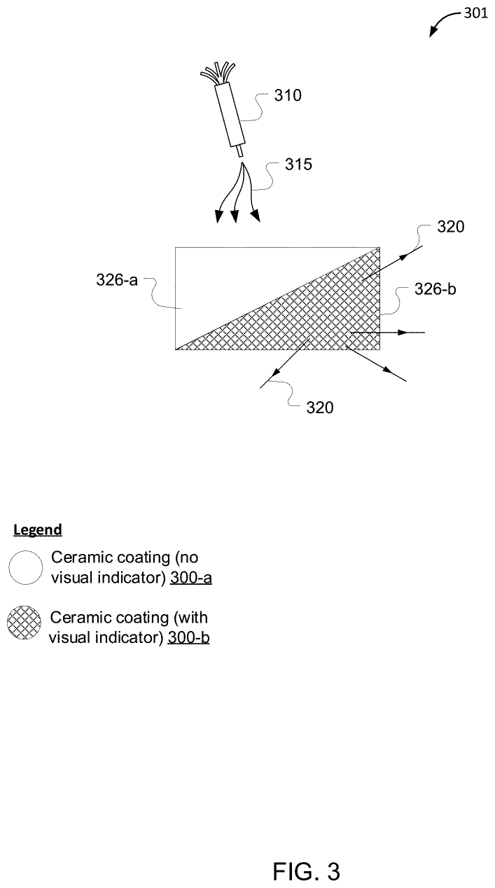

FIG. 3 illustrates a system 301 comprising two substrates (e.g., automotive trim panels 326-a and 326-b) coated with the same ceramic coating formulation, but only one of them containing a visual indicator (e.g., fluorescent optical brightener, phosphorescent indicator, etc.), and exposed to UV light 315, in accordance with one or more implementations. In some cases, the trim panels 326 may be composed of plastic, metal, fiberglass, or any other relevant material. In some examples, FIG. 3 may implement one or more aspects of the figures described herein.

As shown, trim panel 326-a may be coated with a ceramic coating 300-a without any visual indicators. The ceramic coating 300-a may be similar or substantially similar to the ceramic coatings 100-a and 200-a previously described in relation to FIGS. 1 and 2. Further, automotive trim panel 326-b may be coated with ceramic coating 300-b comprising a visual indicator, such as a fluorescing optical brightener. Ceramic coating 300-b may implement one or more aspects of the ceramic coatings 100-b and/or 200-b described in relation to FIGS. 1 and 2.

Like FIGS. 1 and 2, trim panels 326-a and 326-b may be illuminated by UV light 315 from a UV source 310. The UV source 310 may be a hand-held black light, for instance, although other UV sources are contemplated in different embodiments. In some cases, the presence of the visual indicator in ceramic coating 300-b may cause the ceramic coating applied to trim panel 326-b to glow under UV light conditions, whereas the ceramic coating 300-a applied to trim panel 326-a may not exhibit such properties. It should be noted that, in some circumstances, the visual indicator may minimize changes in the aesthetics of the ceramic coating 300-b and/or the trim panel 326-b, for instance, by allowing the ceramic coating 300-b to remain unperceivable under visible light conditions. As shown, plastic trim panel 326-b may re-emit visible light 320 after being illuminated with UV light 315, where the emission of visible 320 may be instantaneous or nearly instantaneous (i.e., if the visual indicator is a fluorescing optical brightener), or slightly delayed (i.e., if the visual indicator is a phosphorescent indicator). Contrastingly, trim panel 326-a coated with ceramic coating 300-a (i.e., without any visual indicators) may not re-emit light in the visible region upon illumination by UV light 315.

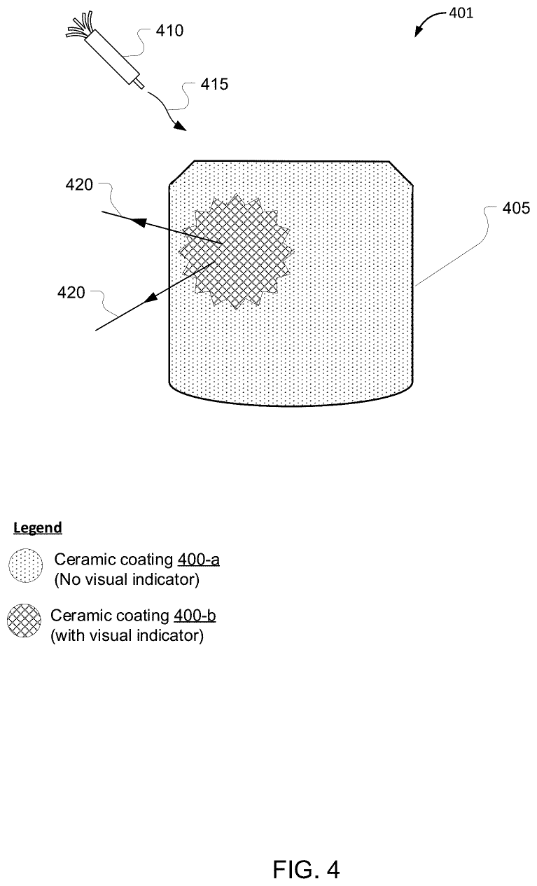

FIG. 4 illustrates a system 401 comprising a substrate, such as refrigerator 405, partially coated with a ceramic coating 400-a containing no visual indicators and partially coated with a ceramic coating 400-b with a visual indicator (e.g., fluorescent optical brightener, phosphorescent indicator, etc.), in accordance with one or more implementations. As illustrated, the refrigerator 405 may be exposed to UV light 415 from a UV source 410. Further, the surface of the refrigerator 405 comprising the ceramic coatings may be made of metal (e.g., steel, stainless steel, or any other applicable metal or alloy), plastic, etc. In some cases, FIG. 4 may implement one or more aspects of the figures described herein. In some examples, the ceramic coating 400-a may be similar or substantially similar to the ceramic coatings 100-a, 200-a, and/or 300-a previously described in relation to FIGS. 1-3. Further, the ceramic coating 400-b may implement one or more aspects of the ceramic coatings 100-b, 200-b, and/or 300-b described in relation to FIGS. 1-3.

Upon being exposed to UV light 415, the visual indicator in ceramic coating 400-b may cause the ceramic coating to glow (e.g., emit visible light), unlike the ceramic coating 400-a. As previously described, in some circumstances, the visual indicator may not alter the aesthetics of the ceramic coating 400-b and may allow the ceramic coating 400-b to remain unperceivable on the refrigerator 405 under visible light conditions. Said another way, under visible light conditions, the ceramic coating 400-a and ceramic coating 400-b may appear identical on the surface of the refrigerator 405. For instance, the ceramic coatings 400-a and 400-b may remain invisible (or nearly invisible) when applied on the refrigerator. In another case, the ceramic coatings 400-a and 400-b may enhance gloss of the refrigerator's surface, for instance. In either case, the surface of the refrigerator 405 comprising the different ceramic coating formulations (i.e., with and without the visual indicator) may appear homogenous and seamless to an observer viewing the refrigerator under visible light.

As illustrated, the region of the fridge comprising the ceramic coating 400-b may re-emit visible light 420 after being illuminated with UV light 415. In some cases, the emission of visible 420 may be instantaneous or nearly instantaneous (i.e., if the visual indicator is a fluorescing optical brightener), or slightly delayed (i.e., if the visual indicator is a phosphorescent indicator). Contrastingly, upon illumination with the UV light 415, the region of the fridge comprising the ceramic coating 400-a (i.e., with no visual indicators) may not re-emit light in the visible region.

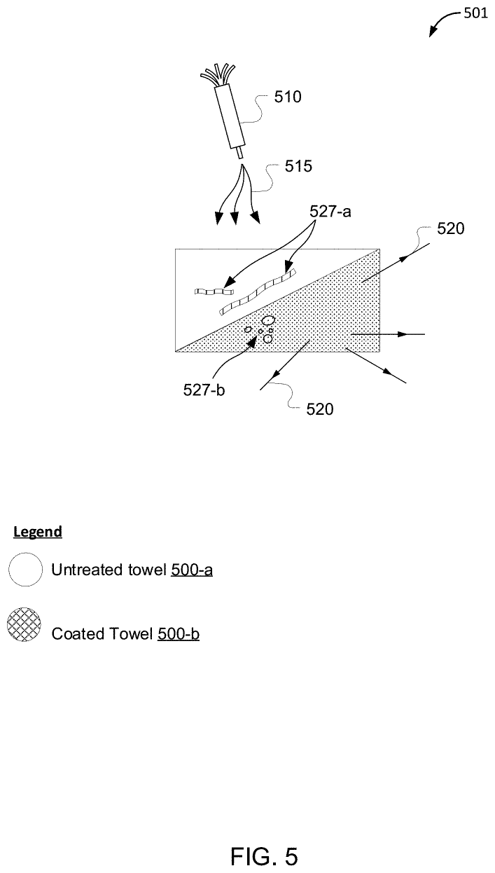

FIG. 5 illustrates a system 501 comprising a pair of identical microfiber towels 500-a and 500-b. Microfiber towels 500-a and 500-b may be examples of substrates. As shown, towel 500-a is an untreated towel without any ceramic coating and/or visual indicator(s). Further, towel 500-b is coated with a sprayable ceramic coating formulation with a visual indicator. In some embodiments, towel 500-b may exhibit hydrophobic behavior when exposed to water. Further, towel 500-b may fluoresce while exposed to UV light (e.g., from a handheld black light) due to the presence of the visual indicator included within the formulation. In some cases, FIG. 5 may implement one or more aspects of the figures described herein. In some cases, the visual indicator may comprise a fluorescent optical brightener, a phosphorescent indicator, an optical brightening agent, a fluorescent brightening agent, or a fluorescent whitening agent, to name a few non-limiting examples. The visual indicator may be included within the ceramic coating formulation for instance, to ensure even coverage of the coating on the textile (e.g., towel 500-b). It should be noted that, the towel may be composed of cotton, polyester, nylon, a cotton blend, a synthetic blend, microfiber, micro suede, or any other applicable material. In some embodiments, the ceramic coating applied to towel 500-b may be similar or substantially similar to the ceramic coatings 100-b, 200-b, 300-b, and/or 400-b previously described in relation to FIGS. 1-4.

In some cases, the towels 500-a and 500-b may be illuminated by UV light 515 from UV source 510. The UV source may be a hand-held black light, for example. In some cases, the presence of the visual indicator in the ceramic coating applied to towel 500-b may cause the ceramic coating to glow under UV light conditions. As shown, upon illumination by the UV light 515-a, towel 500-b may glow and emit visible light 520. It should be noted that, the visual indicator may not alter the aesthetics of the ceramic coating on towel 500-b and may allow the ceramic coating to remain unperceivable on the towel under visible light conditions. For example, the towel 500-b may retain its original color and other properties (e.g., brightness, absorbency, feel on skin, etc.) even after being coated with the ceramic coating.

Additionally or alternatively, the presence of the ceramic coating may impart one or more physical properties, such as hydrophobicity (e.g., contact less >90 degrees). As shown, water 527-b may bead up and form droplets on the surface of the towel 500-b, while the towel 500-a may not exhibit such properties. In some cases, the contact angle of water droplets on the surface of towel 500-b may be at least 90 degrees or 120 degrees. In other cases, the contact angle may be less than 90 degrees or 45 degrees (i.e., hydrophilic). In some examples, water 527-a on the surface of towel 500-a may be visible as wet streaks due to the lack of the ceramic coating. In such cases, water 527-a may seep into the towel through its top surface and may be absorbed by the towel 500-a.

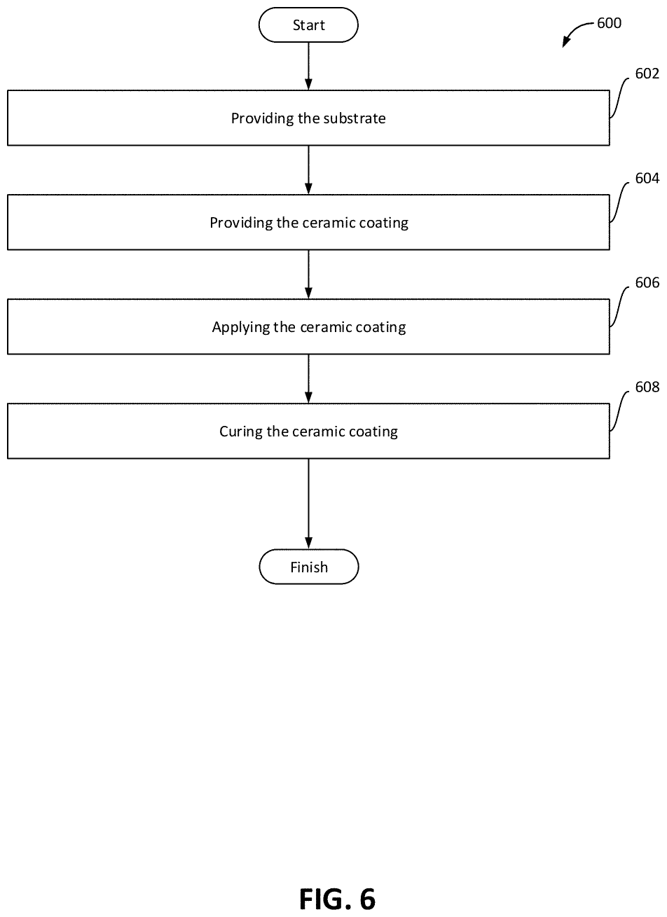

FIG. 6 illustrates a method 600 for using a ceramic coating with a visual indicator for visual identification and detection, in accordance with one or more implementations. In some cases, the visual indicator may provide for visual detection and identification of a ceramic coating on a substrate. In some cases, method 600 may implement one or more aspects of the figures described herein.

In some cases, at 602, the method 600 may include providing a substrate. Some non-limiting examples of substrates may include: plastic, metal, wood, polymers, glass, fabric (e.g., cotton, polyester, nylon, cotton blend, synthetic blend, etc.), stone, fiberglass, ceramic or porcelain tiles, etc.

At 604, the method 600 may include providing a ceramic coating. As previously described, the ceramic coating formulation may comprise a solvent (e.g., organic or inorganic solvent) and a liquid polymer (or a blend of liquid polymers) capable of providing a semi-permanent or permanent film layer on a given substrate, for instance, upon curing at ambient temperature. Some non-limiting examples of the liquid polymer(s) may include one or more of trimethoxysilicate fluids or resins, silazane, polysilazane, polysiloxazane, perhydropolysilazane, dimethylpolysilazane, hexamethyldisilazane, 1,1,3,3-tetramethyldisilazane, 2,2,4,4,6,6-hexamethylcyclotrisilazane, 1,3-Diethyl-1,1,3,3-tetramethyldisilazane, 2,4,6-trimethyl-2,4,6-trivinylcyclotrisilazane, 1,1,3,3-Tetramethyl-1,3-diphenyldisilazane, or 1,3-dimethyl-1,1,3,3-tetraphenyldisilazane. In some circumstances, the liquid polymer(s) may comprise solutions of the aforementioned chemicals in one of an organic or an inorganic solvent, such as a volatile cyclic siloxane blend of octamethylcyclotetrasiloxane and decamethylcyclotetrasiloxane. In some cases, the organic solvent may comprise toluene, kerosene, xylene, alcohols, esters, glycol ethers, tert-butyl acetate, n-butyl acetate, etc., to name a few non-limiting examples. In some cases, water may be used as an inorganic solvent.

Additionally or alternatively, the ceramic coating formulation may also comprise additive fluids and polymers, or other catalysts, which may impart additional physical properties to the cured coating, such as, but not limited to, hydrophobic or hydrophilic behavior, scratch and mar resistance, gloss, lower coefficient of friction or slickness, adhesion, anti-graffiti, UV resistance, odor control, viscosity, and detergency or chemical resistance. These additive fluids and/or polymers may be selected from a group consisting of fluorocarbons, fluorosilicones, silanes, amino-functional polymers, amino-functional silicones, polydimethylsiloxane (PDMS), or trimethoxysilicates. In some examples, these additive fluids and/or polymers may be in the form of a ready to use solution of the aforementioned chemicals in the same or an alternative organic or inorganic solvent(s) than that used for the liquid polymer. As described above, these additive fluids and/or polymers may be in amounts from about 2.5% to 4.5% by weight based on a total weight of the ceramic coating formulation, or alternatively, the solvent. It should be noted that, different loading levels that are higher or lower than described herein may be contemplated in other embodiments.

In some embodiments, the ceramic coating formulation may also comprise a visual indicator, such as those described above. In some circumstances, the visual indicator may assist in the positive identification of the ceramic coating formulation's presence and its whereabouts on the substrate. In some embodiments, the visual indicator may be selected from a group consisting of a fluorescing optical brightener, optical brightening agent, fluorescent brightening agent, fluorescent whitening agent, or phosphorescent indicator. The visual indicator may be in the form of a solid powder or liquid pigment or dye. In some examples, the visual indicator may be added to the ceramic coating prior to application on the substrate. In some cases, this positive identification may serve to provide additional utility in the form of visual distinction relative to currently used techniques (e.g., visual indicator may not alter the aesthetics of the substrate), aided visualization during application, enhancements in training and application methods, wear and weatherability indication, layering identification, ease of maintenance assessment, state of leveling and cure. In some aspects, the use of a visual indicator may also serve to provide demonstrable proof of positive application and results to a potential client, customer, or installation technician.

At 606, the method 600 may include applying the ceramic coating comprising the visual indicator to the substrate. The ceramic coating formulation may be applied using hand (e.g., directly or via an applicator, such as a micro suede applicator pad, a sponge applicator, or another ceramic coating applicator), a detail spray, etc.

At 608, the method 600 may include curing the ceramic coating formulation on the substrate. In some cases, the one or more liquid polymers in the ceramic coating may be adapted to cure at or near ambient room temperature (e.g., 22 degrees Celsius). Upon curing, the one or more liquid polymers may cure and harden into a semi-permanent or permanent film layer on the given substrate. In some cases, the cured film layer of this polymer-based formulation may be composed of one or more of quartz or silicon dioxide, silicon carbide, titanium oxide, antimony-tin oxide, graphene oxide, reduced graphene oxide, or other metal oxides. Furthermore, the presence of the visual indicator may cause the ceramic coating on the substrate to glow, for instance, under UV light conditions. In such cases, the ceramic coating may emit visible light instantaneously or with a slight delay, based on the visual indicator (e.g., fluorescing optical brightener, phosphorescent indicator, etc.) included in the formulation.

### Further Embodiments

In some embodiments, a ceramic coating formulation comprising a visual indicator may be utilized to coat a substrate (e.g., plastic, metal, wood, polymers, etc.), where the visual indicator may assist in the positive identification of the ceramic coating formulation's presence and whereabouts on the substrate. In some embodiments, the visual indicator may be selected from a group consisting of a fluorescing optical brightener, optical brightening agent, fluorescent brightening agent, fluorescent whitening agent, or phosphorescent indicator. The visual indicator may be in the form of a solid powder or liquid pigment or dye, and may be added to the ceramic coating prior to application on the substrate. In some cases, this positive identification may serve to provide additional utility marketed in the form of visual distinction relative to currently used techniques (e.g., visual indicator may not alter the aesthetics of the substrate), aided visualization during application, enhancements in training and application methods, wear and weatherability indication, layering identification, ease of maintenance assessment, state of leveling and cure. In some aspects, the use of a visual indicator may also serve to provide demonstrable proof of positive application and results to an end user (e.g., potential client, customer, or installation technician).

In some cases, the ceramic coating formulation may consist of a liquid polymer, or a blend of liquid polymers capable of providing a semi-permanent or permanent film layer on a given substrate, for instance, upon curing at ambient temperature. While generally described as being cured at ambient or room temperature, different curing temperatures and conditions are contemplated in other embodiments. In some cases, the cured film layer of this polymer-based formulation may be composed of one or more of quartz or silicon dioxide, silicon carbide, titanium oxide, antimony-tin oxide, graphene oxide, reduced graphene oxide, or other metal oxides. Furthermore, the liquid polymer(s) may include one or more of trimethoxysilicate fluids or resins, silazane, polysilazane, polysiloxazane, perhydropolysilazane, dimethylpolysilazane, hexamethyldisilazane, 1,1,3,3-tetramethyldisilazane, 2,2,4,4,6,6-hexamethylcyclotrisilazane, 1,3-Diethyl-1,1,3,3-tetramethyldisilazane, 2,4,6-trimethyl-2,4,6-trivinylcyclotrisilazane, 1,1,3,3-Tetramethyl-1,3-diphenyldisilazane, or 1,3-dimethyl-1,1,3,3-tetraphenyldisilazane. In some circumstances, the liquid polymer(s) may comprise solutions of the aforementioned chemicals in one of an organic or an inorganic solvent.

In some examples, the ceramic coating formulation may also comprise additive fluids and polymers, or other catalysts, which may impart additional physical properties to the cured coating, such as, but not limited to, hydrophobic or hydrophilic behavior, scratch and mar resistance, gloss, lower coefficient of friction or slickness, adhesion, anti-graffiti, UV resistance, and detergency or chemical resistance. These additive fluids and/or polymers may be selected from a group consisting of fluorocarbons, fluorosilicones, silanes, amino-functional polymers, amino-functional silicones, polydimethylsiloxane (PDMS), or trimethoxysilicates. In some examples, these additive fluids and/or polymers may be in the form of a solution of the aforementioned chemicals in organic or inorganic solvents.

In some embodiments, the ceramic coating formulation may be employed in a variety of use cases, for instance, fabric protectants, aerosols, paste or liquid waxes, crème lotions, automotive paint sealants (i.e., liquid and/or spray), leather protectants, water-based and solvent-based detail sprays (e.g., for both interior and exterior applications), tunnel wash or automatic in-bay car washes, wash and waxes, and/or other automotive shampoos (i.e., applied via hand, or utilizing any of a foam gun, foam cannon, or other type of hydrofoamer).

1. A ceramic coating formulation, comprising:
a solvent, wherein the solvent is one of an organic or an inorganic solvent;
one or more liquid polymers, wherein the one or more liquid polymers are solvated in the solvent;
a visual indicator, wherein the visual indicator is one of a fluorescing optical brightener, a phosphorescent indicator, an optical brightening agent (OBA), a fluorescent brightening agent (FBA), or a fluorescent whitening agent (FWA);
wherein the visual indicator provides for one or more of a positive identification of the ceramic coating formulation's presence on a coated substrate, visual distinction, visual detection, aided visualization during training, application, wear indication, weatherability indication, layering identification, maintenance assessment, leveling state, and a curing state.

2. The ceramic coating formulation of claim 1, wherein the one or more liquid polymers are adapted to cure at or near room temperature into a semi-permanent or permanent film layer on a substrate, and wherein the semi-permanent or permanent film layer is composed of at least one of quartz or silicon dioxide, silicon carbide, titanium oxide, antimony-tin oxide, graphene oxide, and reduced graphene oxide.

3. The ceramic coating formulation of claim 1, wherein the one or more liquid polymers are selected from a group consisting of trimethoxysilicate fluids or resins, silazane, polysilazane, polysiloxazane, perhydropolysilazane, dimethylpolysilazane, hexamethyldisilazane, 1,1,3,3-tetramethyldisilazane, 2,2,4,4,6,6-hexamethylcyclotrisilazane, 1,3-Diethyl-1,1,3,3-tetramethyldisilazane, 2,4,6-trimethyl-2,4,6-trivinylcyclotrisilazane, 1,1,3,3-Tetramethyl-1,3-diphenyldisilazane, or 1,3-dimethyl-1,1,3,3-tetraphenyldisilazane.

4. The ceramic coating formulation of claim 1, further comprising:
one or more of additive fluids and polymers adapted to vary one or more physical characteristics of the ceramic coating formulation, the physical characteristics selected from a group consisting of hydrophobic or hydrophilic behavior, scratch resistance, mar resistance, gloss, coefficient of friction or slickness, adhesion, anti-graffiti, ultraviolet (UV) resistance, detergency resistance, or chemical resistance.

5. The ceramic coating formulation of claim 4, wherein the one or more additive fluids are selected from a group consisting of: fluorocarbons, fluorosilicones, silanes, amino-functional polymers, amino-functional silicones, polydimethylsiloxane (PDMS), or trimethoxysilicates, and wherein the one or more additive fluids further comprise one of an organic and an inorganic solvent.

6. The ceramic coating formulation of claim 1, wherein the fluorescing optical brightener is one of a water-borne optical brightener or a solvent-borne optical brightener.

7. The ceramic coating formulation of claim 1, wherein the phosphorescent indicator is one of a water-borne phosphorescent indicator or a solvent-borne phosphorescent indicator.

8. The ceramic coating formulation of claim 1, wherein the solvent is selected from a group consisting of toluene, xylene, ketone, ester, alcohol, glycol ether, glycol ether ester, or parachlorobenzotrifluoride (PCBTF).

9. The ceramic coating formulation of claim 1, wherein the visual indicator is configured to allow the ceramic coating formulation to be perceivable within an ultraviolet (UV) region of the electromagnetic spectrum.

10. The ceramic coating formulation of claim 1, wherein the visual indicator is one of a solid powder, a liquid pigment, or a liquid dye.

11. A method for visual identification and detection of a ceramic coating on a substrate, comprising:
providing the substrate;
providing the ceramic coating;
applying the ceramic coating to the substrate, wherein the ceramic coating is comprised of:
a solvent, wherein the solvent is one of an organic or an inorganic solvent;
one or more liquid polymers, wherein the one or more liquid polymers are solvated in the solvent;
one or more additive fluids, polymers, or a combination; and
a visual indicator, wherein the visual indicator is one of a fluorescing optical brightener, a phosphorescent indicator, an optical brightening agent (OBA), a fluorescent brightening agent (FBA), or a fluorescent whitening agent (FWA); and
curing the ceramic coating on the substrate.

12. The method of claim 11, wherein curing the ceramic coating comprises:
curing the one or more liquid polymers at or near room temperature into a semi-permanent or permanent film layer on the substrate, wherein the semi-permanent or permanent film layer is composed of at least one of quartz or silicon dioxide, silicon carbide, titanium oxide, antimony-tin oxide, graphene oxide, and reduced graphene oxide.

13. The method of claim 11, wherein the one or more liquid polymers are selected from a group consisting of trimethoxysilicate fluids or resins, silazane, polysilazane, polysiloxazane, perhydropolysilazane, dimethylpolysilazane, hexamethyldisilazane, 1,1,3,3-tetramethyldisilazane, 2,2,4,4,6,6-hexamethylcyclotrisilazane, 1,3-Diethyl-1,1,3,3-tetramethyldisilazane, 2,4,6-trimethyl-2,4,6-trivinylcyclotrisilazane, 1,1,3,3-Tetramethyl-1,3-diphenyldisilazane, or 1,3-dimethyl-1,1,3,3-tetraphenyldisilazane.

14. The method of claim 11, wherein the one or more of additive fluids and polymers are adapted to vary one or more physical characteristics of the ceramic coating, the physical characteristics selected from a group consisting of hydrophobic or hydrophilic behavior, scratch resistance, mar resistance, gloss, coefficient of friction or slickness, adhesion, anti-graffiti, ultraviolet (UV) resistance, detergency resistance, or chemical resistance.

15. The method of claim 14, wherein the one or more additive fluids, polymers, or a combination, are selected from a group consisting of: fluorocarbons, fluorosilicones, silanes, amino-functional polymers, amino-functional silicones, polydimethylsiloxane (PDMS), or trimethoxysilicates, and wherein the one or more additive fluids, polymers, or a combination, further comprise one of an organic and an inorganic solvent.

16. The method of claim 11, wherein the fluorescing optical brightener is one of a water-borne optical brightener or a solvent-borne optical brightener.

17. The method of claim 11, wherein the phosphorescent indicator is one of a water-borne phosphorescent indicator or a solvent-borne phosphorescent indicator.

18. The method of claim 11, wherein the solvent is a toluene, a xylene, a ketone, an ester, an alcohol, a glycol ether, a glycol ether ester, or parachlorobenzotrifluoride (PCBTF).

19. The method of claim 11, wherein the visual indicator is configured to allow the ceramic coating to be perceivable within an ultraviolet (UV) region of the electromagnetic spectrum.

20. The method of claim 11, wherein the visual indicator is one of a solid powder, a liquid pigment, or a liquid dye.
